(19) United States
(12) Patent Application Publication
(10) Pub. No.: US 2019/0126536 A1
(43) Pub. Date: May 2, 2019

(54) CARTRIDGE VAT-BASED ADDITIVE MANUFACTURING APPARATUS AND METHOD

(71) Applicant: General Electric Company, Schenectady, NY (US)

(72) Inventor: Mary Kathryn Thompson, North Huntingdon, PA (US)

(21) Appl. No.: 15/802,334

(22) Filed: Nov. 2, 2017

(51) Int. Cl. B29C 64/135; B29C 64/245; B29C 64/227; B29C 64/264; B29C 64/357

(52) U.S. Cl. CPC B29C 64/135; B29C 64/245; B33Y 10/00; B29C 64/264; B29C 64/357; B29C 64/227

(57) ABSTRACT

A method for producing a component layer-by-layer includes: placing in a loading zone a vat; loading the vat into a build zone of an additive manufacturing apparatus utilizing a vat transport mechanism; executing a build cycle, including: positioning a stage relative to the build surface so as to define a layer increment in the resin; selectively curing a resin contained within the vat using application of radiant energy in a specific pattern so as to define the geometry of a cross-sectional layer of the component; moving the vat and the stage relatively apart so as to separate the component from the build surface; unloading the vat from the build zone into an unloading zone; and repeating the steps of placing, loading, executing the build cycle, and unloading, for a plurality of layers, using a plurality of vats in series, until the component is complete.

### BACKGROUND OF THE INVENTION

This invention relates generally to additive manufacturing, and more particularly to methods for curable material handling in additive manufacturing.

Additive manufacturing is a process in which material is built up layer-by-layer to form a component. Stereolithography is a type of additive manufacturing process which employs a vat of liquid radiant-energy curable photopolymer “resin” and a curing energy source such as a laser. Similarly, DLP 3D printing employs a two-dimensional image projector to build components one layer at a time. For each layer, the projector flashes a radiation image of the cross-section of the component on the surface of the liquid or through a transparent object which defines a constrained surface of the resin. Exposure to the radiation cures and solidifies the pattern in the resin and joins it to a previously-cured layer. Other types of additive manufacturing processes utilize other types of radiant energy sources to solidify patterns in resin.

In curing the photopolymer resin, it is preferable to have new, fresh material for each layer. Old resin may contain cured products such as supports that are broken off of the part or other external contamination. In a vat-based process, this contamination or the contaminated material can cure into the component, resulting in undesirable geometry, or otherwise disrupt the build process and damage the final part.

Another prior art method is a so-called “tape casting” process. In this process, a resin is deposited onto a flexible radiotransparent tape that is fed out from a supply reel. An upper plate lowers on to the resin, compressing it between the tape and the upper plate and defining a layer thickness. Radiant energy is used to cure the resin through the radiotransparent tape. Once the curing of the first layer is complete, the upper plate is retracted upwards, taking the cured material with it. The tape is then advanced to expose a fresh clean section, ready for additional resin. One problem with tape casting is that it is wasteful because the tape is not reusable.

### BRIEF DESCRIPTION OF THE INVENTION

At least one of these problems is addressed by an additive manufacturing method in which material is contained and cured in a vat that is one of a plurality of vats. A fresh vat of material can be provided for a subsequent curing cycle.

According to one aspect of the technology described herein, a method for producing a component layer-by-layer includes the steps of: placing in a loading zone a vat having a floor including at least a portion which is transparent, the floor defining a build surface; loading the vat into a build zone of an additive manufacturing apparatus utilizing a vat transport mechanism; executing a build cycle, including the steps of: positioning a stage relative to the build surface so as to define a layer increment in the resin; selectively curing a resin contained within the vat using an application of radiant energy in a specific pattern so as to define the geometry of a cross-sectional layer of the component; moving the vat and the stage relatively apart so as to separate the component from the build surface; unloading the vat from the build zone into an unloading zone; and repeating the steps of placing, loading, executing the build cycle, and unloading for a plurality of layers, using a plurality of vats in series, until the component is complete.

According to another aspect of the technology described herein, an additive manufacturing apparatus includes: a vat transport mechanism operable to selectively move a series of vats each including a floor defining a build surface in sequence through a build zone defined within the apparatus; a stage positioned adjacent to the build zone and configured to hold a stacked arrangement of one or more cured layers of a radiant-energy-curable resin; a mechanism operable to manipulate a relative position of the build surface and the stage; a radiant energy apparatus positioned adjacent to the build zone opposite to the stage, and operable to generate and project radiant energy through the floor in a predetermined pattern.

### BRIEF DESCRIPTION OF THE DRAWINGS

The invention may be best understood by reference to the following description taken in conjunction with the accompanying drawing figures in which:

FIG. 1 is a schematic side elevation view of an exemplary additive manufacturing apparatus;

FIG. 2 is a view of the apparatus of FIG. 1, showing a stage lowered into place;

FIG. 3 shows a layer of resin being cured using a radiant energy apparatus;

FIG. 4 is a view of the apparatus of FIG. 1, showing a stage retracted;

FIG. 5 is a view of the apparatus of FIG. 1, showing a vat moved out of a build zone of the apparatus;

FIG. 6 is a view of the apparatus of FIG. 1, showing curable material being applied to a vat within a build zone of the apparatus;

FIG. 7 is a schematic top plan view of a layer of resin having multiple sections defined by a divided vat in the apparatus of FIG. 1;

FIG. 8 is a schematic side elevation view of an alternative additive manufacturing apparatus;

FIG. 9 is a view of the apparatus of FIG. 1, showing a cleaning vat moved into position in a build zone of the apparatus;

FIG. 10 is a schematic side elevation view of a stage and a vat containing cleaning fluid; and

FIG. 11 is a schematic side elevation view of a stage in an empty vat equipped with air nozzles.

### DETAILED DESCRIPTION OF THE INVENTION

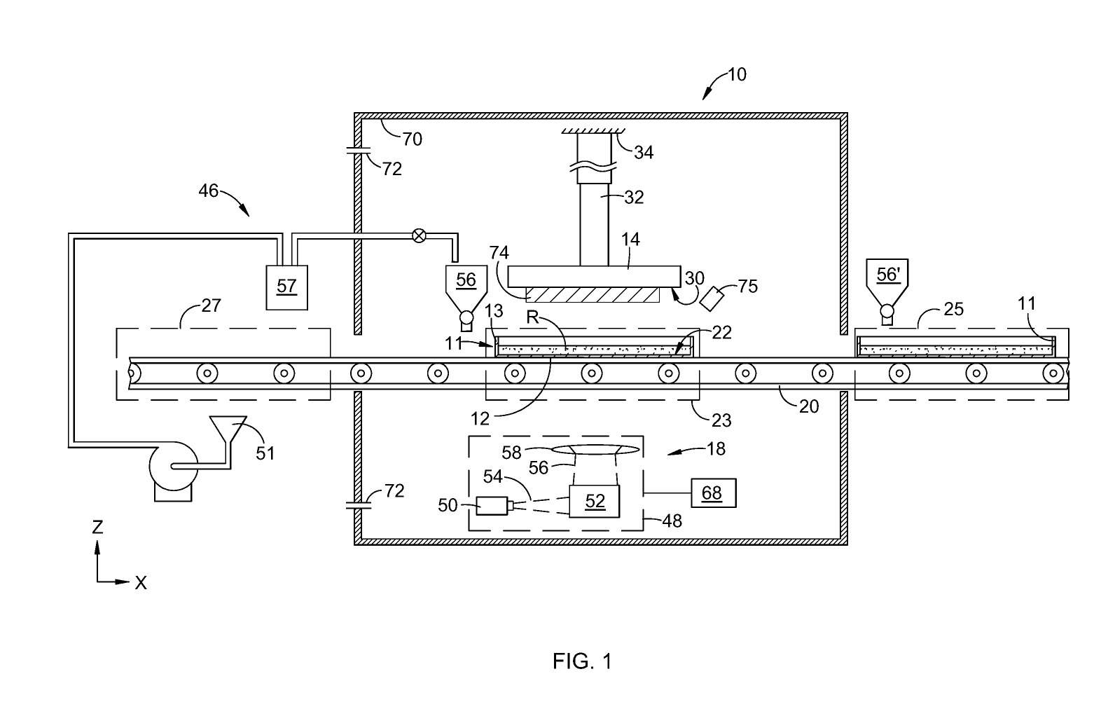

Referring to the drawings wherein identical reference numerals denote the same elements throughout the various views, FIG. 1 illustrates schematically an example of one type of suitable apparatus 10 for carrying out an embodiment of an additive manufacturing method as described herein. The method provides for the use of a plurality of vats 11 for sequential use with the apparatus 10. As a result, multiple layers can be made such that sequential layers can be made with different resins. In addition, the vats can be cleaned as subsequent layers are being produced.

The method is primarily intended for use with lower viscosity resins, slurries, and pastes. The method could also be used with higher viscosity resins and/or powders. It will be understood that other configurations of equipment may be used to carry out the method. Basic components of the exemplary apparatus 10 include a stage 14, a radiant energy apparatus 18, and a vat transport mechanism 20.

Each of the vats 11 includes a floor 12 and a perimeter or walls 13 such that the vat is configured to receive a radiant-energy-curable resin R. The floor 12 is transparent or includes a portion or portions that are transparent. As used herein, the term “transparent” refers to a material which allows radiant energy of a selected wavelength to pass through. For example, as described below, the radiant energy used for curing could be ultraviolet light or laser light in the visible spectrum. Non-limiting examples of transparent materials include polymers, glass, and crystalline minerals such as sapphire or quartz. The floor 12 could be made up of two or more subcomponents, some of which are transparent.

The floor 12 of the vat 11 defines build surface 22 which may be planar. For purposes of convenient description, the build surface 22 may be considered to be oriented parallel to an X-Y plane of the apparatus 10, and a direction perpendicular to the X-Y plane is denoted as a Z-direction (X, Y, and Z being three mutually perpendicular directions).

The build surface 22 may be configured to be “non-stick”, that is, resistant to adhesion of cured resin. The non-stick properties may be embodied by a combination of variables such as the chemistry of the floor 12, its surface finish, and/or applied coatings. In one example, a permanent or semi-permanent non-stick coating may be applied. One non-limiting example of a suitable coating is polytetrafluoroethylene (“PTFE”). In one example, all or a portion of the build surface 22 of vat 11 may incorporate a controlled roughness or surface texture (e.g. protrusions, dimples, grooves, ridges, etc.) with nonstick properties. In one example, the floor 12 may be made in whole or in part from an oxygen-permeable material.

An area or volume immediately surrounding the location of the vat 11 (when it is positioned for a curing step to take place) is defined as a “build zone”, denoted by a dashed-line box 23. For purposes of description, the apparatus 10 may be associated with a “loading zone” 25 positioned in near proximity to the build zone 23, and an “unloading zone” 27 positioned in near proximity to the build zone 23. (Alternatively, a single buffer or staging zone may be provided).

The vat transport mechanism 20 comprises a device or combination of devices operable to move a vat 11 from the loading zone 25 into the build zone 23, or from the build zone 23 into the unloading zone 27. It should be appreciated that in some embodiments, the loading zone 25 and the unloading zone 27 can be combined such that loading activities and unloading activities occur at the same location.

In the illustrated example, one possible vat transport mechanism 20 is shown in the form of a conveyor belt which extends laterally through the build zone 23. Other types of mechanisms suitable for this purpose include, for example, mechanical linkages, rotary tables, or robot effector arms. It will be understood that the vats 11 may be moved into or out of the build zone 23 from any desired direction.

Referring now to the components of apparatus 10, the stage 14 is a structure defining a planar surface 30 which is capable of being oriented parallel to the build surface 22 when the vat 11 is positioned in the build zone. Some means are provided for moving the stage 14 relative to the vat 11, and thus to the build surface 22, parallel to the Z-direction. In FIG. 1, these means are depicted schematically as a simple actuator 32 connected between the stage 14 and a stationary support structure 34, with the understanding that devices such as pneumatic cylinders, hydraulic cylinders, ballscrew electric actuators, linear electric actuators, or delta drives may be used for this purpose. In addition to, or as an alternative to, making the stage 14 movable, the floor 12 and/or the transport mechanism 20 could be movable parallel to the Z-direction.

A resin recovery apparatus 46 may be provided. In the illustrated example, the apparatus 46 includes a screen or filter 51 and a recovered resin reservoir 57. The screen or filter 51 may be provided to remove pieces of partially-cured resin R and other debris from the recovered resin R prior to introduction of the recovered resin to the recovered resin reservoir 57. New resin R and/or filler may be introduced into a vat 11 from a new material reservoir 56. Recycled resin R may be taken from the recovered resin reservoir 57 and mixed into the new material reservoir 56 in whatever proportion desired. Means may be provided for mixing the resin R to ensure the material is homogenous (including for example, any or all of: new resin R, used resin R, new filler, used filler). Optionally, a new material reservoir 56′ may be placed in the loading zone 25, or at some other convenient location.

The radiant energy apparatus 18 may comprise any device or combination of devices operable to generate and project radiant energy on the resin R in a suitable pattern and with a suitable energy level and other operating characteristics to cure the resin R during the build process, described in more detail below.

In one exemplary embodiment as shown in FIG. 1, the radiant energy apparatus 18 may comprise a “projector” 48, used herein generally to refer to any device operable to generate a radiant energy patterned image of suitable energy level and other operating characteristics to cure the resin R. As used herein, the term “patterned image” refers to a projection of radiant energy comprising an array of individual pixels. Non-limiting examples of patterned imaged devices include a DLP projector or another digital micromirror device, a 2D array of LEDs, a 2D array of lasers, or optically addressed light valves. In the illustrated example, the projector 48 comprises a radiant energy source 50 such as a UV lamp, an image forming apparatus 52 operable to receive a source beam 54 from the radiant energy source 50 and generate a patterned image 56 to be projected onto the surface of the resin R, and optionally focusing optics 58, such as one or more lenses.

The radiant energy source 50 may comprise any device operable to generate a beam of suitable energy level and frequency characteristics to cure the resin R. In the illustrated example, the radiant energy source 50 comprises a UV flash lamp.

The image forming apparatus 52 may include one or more mirrors, prisms, and/or lenses and is provided with suitable actuators, and arranged so that the source beam 54 from the radiant energy source 50 can be transformed into a pixelated image in an X-Y plane coincident with the surface of the resin R. In the illustrated example, the image forming apparatus 52 may be a digital micro-mirror device. For example, the projector 48 may be a commercially-available Digital Light Processing (“DLP”) projector.

As an option, the projector 48 may incorporate additional means such as actuators, mirrors, etc. configured to selectively move the image forming apparatus 52 or other part of the projector 48, with the effect of rastering or shifting the location of the patterned image 56 of the build surface 22. Stated another way, the patterned image may be moved away from a nominal or starting location. This permits a single image forming apparatus 52 to cover a larger build area, for example. Means for mastering or shifting the patterned image from the image forming apparatus 52 are commercially available. This type of image projection may be referred to herein as a “tiled image”.

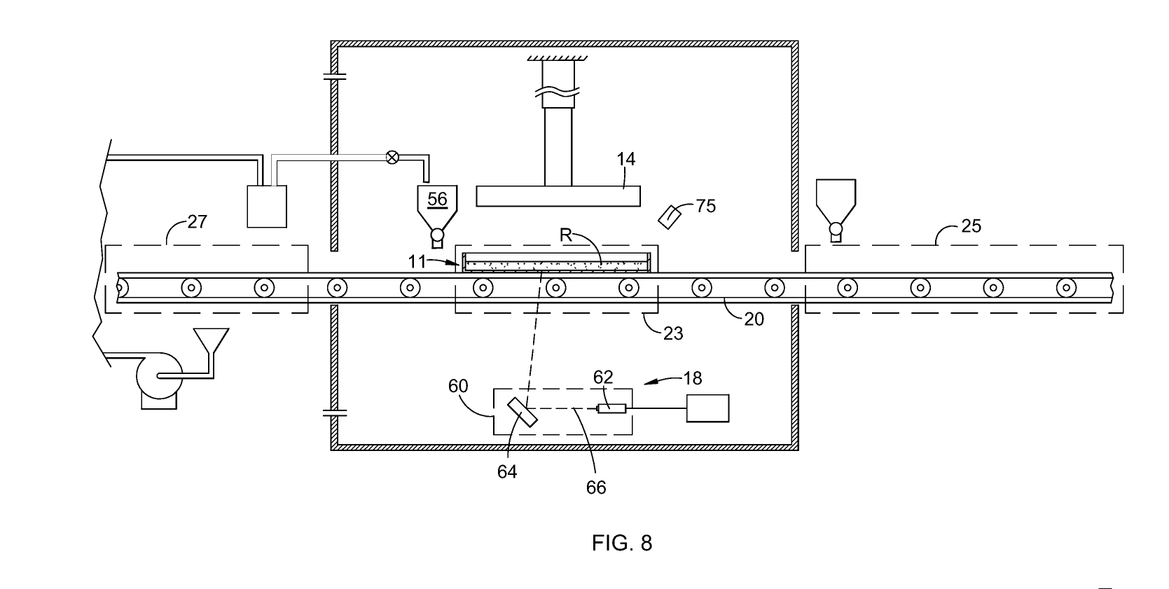

In another exemplary embodiment as shown in FIG. 8, in addition to other types of radiant energy devices, the radiant energy apparatus 18 may comprise a “scanned beam apparatus” 60 used herein to refer generally to refer to any device operable to generate a radiant energy beam of suitable energy level and other operating characteristics to cure the resin R and to scan the beam over the surface of the resin R in a desired pattern. In the illustrated example, the scanned beam apparatus 60 comprises a radiant energy source 62 and a beam steering apparatus 64.

The radiant energy source 62 may comprise any device operable to generate a beam of suitable power and other operating characteristics to cure the resin R. Non-limiting examples of suitable radiant energy sources include lasers or electron beam guns.

The beam steering apparatus 10 may include one or more mirrors, prisms, and/or lenses and may be provided with suitable actuators, and arranged so that a beam 66 from the radiant energy source 62 can be focused to a desired spot size and steered to a desired position in plane coincident with the surface of the resin R. The beam 66 may be referred to herein as a “build beam”. Other types of scanned beam apparatus may be used. For example, scanned beam sources using multiple build beams are known, as are scanned beam sources in which the radiant energy source itself is movable by way of one or more actuators.

The apparatus 10 may include a controller 68. The controller 68 in FIG. 1 is a generalized representation of the hardware and software required to control the operation of the apparatus 10, the stage 14, the radiant energy apparatus 18, the transport mechanism 20, and the various actuators described above. The controller 68 may be embodied, for example, by software running on one or more processors embodied in one or more devices such as a programmable logic controller (“PLC”) or a microcomputer. Such processors may be coupled to sensors and operating components, for example, through wired or wireless connections. The same processor or processors may be used to retrieve and analyze sensor data, for statistical analysis, and for feedback control.

Optionally, the components of the apparatus 10 may be surrounded by a housing 70, which may be used to provide a shielding or inert gas atmosphere using gas ports 72. Optionally, pressure within the housing 70 could be maintained at a desired level greater than or less than atmospheric. Optionally, the housing 70 could be temperature and/or humidity controlled. Optionally, ventilation of the housing 70 could be controlled based on factors such as a time interval, temperature, humidity, and/or chemical species concentration.

The resin R comprises a material which is radiant-energy curable and which is capable of adhering or binding together the filler (if used) in the cured state. As used herein, the term “radiant-energy curable” refers to any material which solidifies in response to the application of radiant energy of a particular frequency and energy level. For example, the resin R may comprise a known type of photopolymer resin containing photo-initiator compounds functioning to trigger a polymerization reaction, causing the resin to change from a liquid state to a solid state. Alternatively, the resin R may comprise a material which contains a solvent that may be evaporated out by the application of radiant energy. The uncured resin R may be provided in solid (e.g. granular) or liquid form including a paste or slurry.

Generally, the resin R should be flowable. According to the illustrated embodiment, the resin R is preferably a relatively low viscosity liquid that is self-levelling. The resin R can be a liquid having a higher viscosity such that contact with the stage 14 is required to level the resin R. The composition of the resin R may be selected as desired to suit a particular application. Mixtures of different compositions may be used.

The resin R may be selected to have the ability to out-gas or burn off during further processing, such as the sintering process described below.

The resin R may incorporate a filler. The filler may be pre-mixed with resin R, then loaded into the new material reservoir 56. The filler comprises particles, which are conventionally defined as “a very small bit of matter”. The filler may comprise any material which is chemically and physically compatible with the selected resin R. The particles may be regular or irregular in shape, may be uniform or non-uniform in size, and may have variable aspect ratios. For example, the particles may take the form of powder, of small spheres or granules, or may be shaped like small rods or fibers.

The composition of the filler, including its chemistry and microstructure, may be selected as desired to suit a particular application. For example, the filler may be metallic, ceramic, polymeric, and/or organic. Other examples of potential fillers include diamond, silicon, and graphite. Mixtures of different compositions may be used.

The filler may be “fusible”, meaning it is capable of consolidation into a mass upon via application of sufficient energy. For example, fusibility is a characteristic of many available powders including but not limited to: polymeric, ceramic, glass, and metallic.

The proportion of filler to resin R may be selected to suit a particular application. Generally, any amount of filler may be used so long as the combined material is capable of flowing and being leveled, and there is sufficient resin R to hold together the particles of the filler in the cured state.

Examples of the operation of the apparatus 10 will now be described in detail with reference to FIGS. 1-6. It will be understood that, as a precursor to producing a component and using the apparatus 10, the component 74 is software modeled as a stack of planar layers arrayed along the Z-axis. Depending on the type of curing method used, each layer may be divided into a grid of pixels. The actual component 74 may be modeled and/or manufactured as a stack of dozens or hundreds of layers. Suitable software modeling processes are known in the art.

Initially, a vat 11 is introduced or placed onto the transport mechanism 20 in the loading zone 25. The vat 11 may be supplied as a prefilled “cartridge” which is already filled with an appropriate amount of resin R sufficient for one layer or multiple layers. If the vat 11 is a prefilled cartridge, then the steps of (optionally) applying a nonstick material to the build surface 22 and filling the vat 11 with resin described below will have been completed offline. In other words, when provided as a cartridge, the vat 11 has been prepared and filled before it is introduced into the loading zone 25. Next, the transport mechanism 20 is used to move the newly introduced vat 11 from the loading zone 25 into the build zone 23.

If the vat 11 if not provided as a prefilled cartridge, then the vat 11 would need to be filled with resin. This filling step could be carried out in the loading zone 25, for example using the new material reservoir 56′, or in the build zone 23, using the new material reservoir 56, or using another new material reservoir (not shown) in some other location. As used herein, the term “filling” refers generally to the act of dispensing, loading, or placing resin R into the vat 11 and does not necessarily imply that the vat 11 be completely filled, or filled to maximum capacity. Thus, the act of “filling” may be partial or complete. Optionally, as a preliminary step in the filling process, a nonstick material may be applied to the build surface 22 prior to resin application. For example, a release agent such as polyvinyl alcohol (“PVA”) may be applied to the build surface 22 prior to each layer being built. In another example, a sacrificial layer having non-stick properties may be applied. A nonstick film, e.g. a polymer sheet or film can be applied to the build surface 22. The film can be removed after a layer is cured.

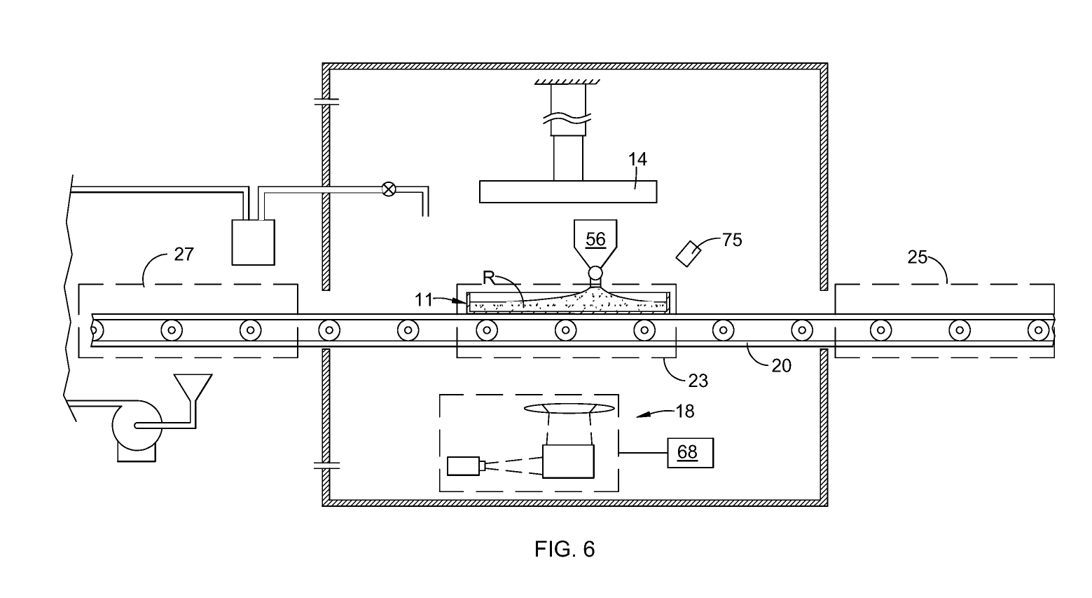

When filling occurs within the build zone 23, the new material reservoir 56 is used to apply resin R to the build surface 22. The quantity of resin R applied may be sufficient for one layer or for multiple layers. It is noted that different vats 11 may be filled to different levels depending on the component geometry and chosen build style. Furthermore, the layer thickness does not have to be uniform from layer to layer. So even if a vat 11 is being filled for just one layer at a time, if the layer thickness changes then so would the vat fill level. In the example shown in FIG. 6, resin flows over the floor 12. In this embodiment of the process, the steps of transporting the vat 11 into the build zone 23 and applying resin R to the build surface 22 would constitute “preparing” the floor 12. When filling occurs within the loading zone 25, the new material reservoir 56′ is used to apply resin R to the build surface 22. The quantity of resin R applied may be sufficient for one layer or for multiple layers. In this embodiment of the process, the steps of applying resin R to the build surface 22 and then transporting the vat 11 into the build zone 23 would constitute “preparing” the floor 12.

Optionally, different layers may comprise two or more different material combinations of resin R and/or filler. As used herein, the term “combination” refers to any difference in either of the constituents. So, for example, a particular resin composition mixed with either of two different filler compositions would represent two different material combinations. For example, one layer may comprise a first combination of resin R and filler, and a second layer may comprise a different combination of resin R and filler. Stated another way, any desired resin and any desired filler can be used for any given layer. The different materials may be provided, for example, by providing multiple cartridges or prefilled vats 11 filled with different materials, or by providing two or more new material reservoirs 56 of the type seen in FIG. 1 Different materials from different reservoirs may be mixed in a particular vat 11, or they may be mixed at some other location before supplying them to a vat 11.

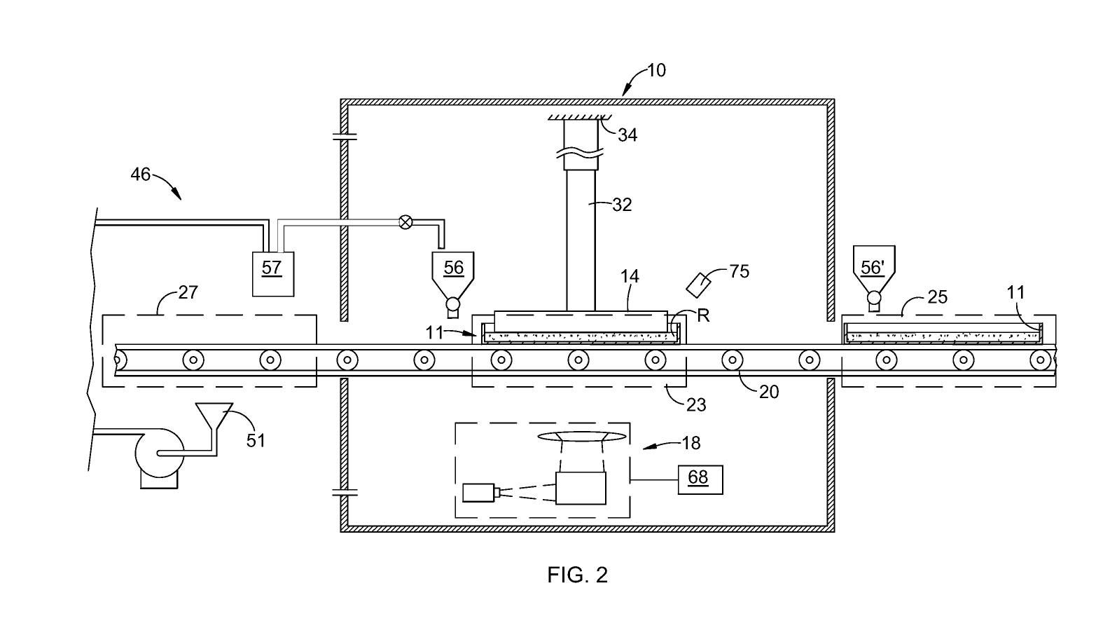

After the material is deposited, the apparatus 10 is positioned to define a selected layer increment. The layer increment is defined by some combination of the depth within the vat 11 to which the resin is filled and the operation of the stage 14. For example, the stage 14 could be positioned such that the upper surface 30 is just touching the applied resin R as shown in FIG. 2, or the stage 14 could be used to compress and displace the resin R to positively define the layer increment. The layer increment affects the speed of the additive manufacturing process and the resolution of the component 74. The layer increment can be variable, with a larger layer increment being used to speed the process in portions of a component 74 not requiring high accuracy, and a smaller layer increment being used where higher accuracy is required, at the expense of process speed.

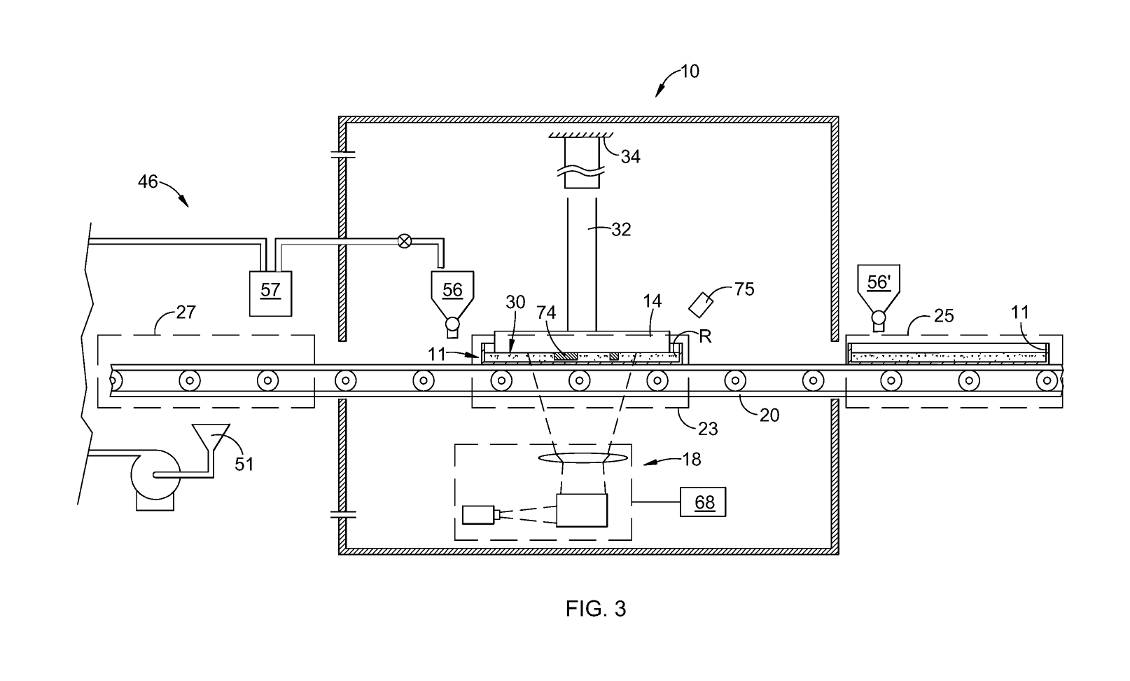

Once the resin R has been applied and the layer increment defined, the radiant energy apparatus 18 is used to cure a two-dimensional cross-section or layer of the component 74 being built as shown in FIG. 3.

Where a projector 48 is used, the projector 48 projects a patterned image 56 representative of the cross-section of the component 74 through the floor 12 to the resin R. This process is referred to herein as “selective” curing. It will be understood that photopolymers undergo degrees of curing. In many cases, the radiant energy apparatus 18 would not fully cure the resin R. Rather, it would partially cure the resin R enough to “gel” and then a post-cure process (described below) would cure the resin R to whatever completeness it can reach. It will also be understood that, when a multi-layer component is made using this type of resin R, the energy output of the radiant energy apparatus 18 may be carefully selected to partially cure or “under-cure” a previous layer, with the expectation that when the subsequent layer is applied, the energy from that next layer will further the curing of the previous layer. In the process described herein, the term “curing” or “cured” may be used to refer to partially-cured or completely-cured resin R. During the curing process, radiant energy may be supplied to a given layer in multiple steps (e.g. multiple flashes) and also may be supplied in multiple different patterns for a given layer. This allows different amounts of energy to be applied to different parts of a layer.

Once curing of the first layer is complete, the stage 14 is separated from the floor 12, for example by raising the stage 14 using the actuator 32.

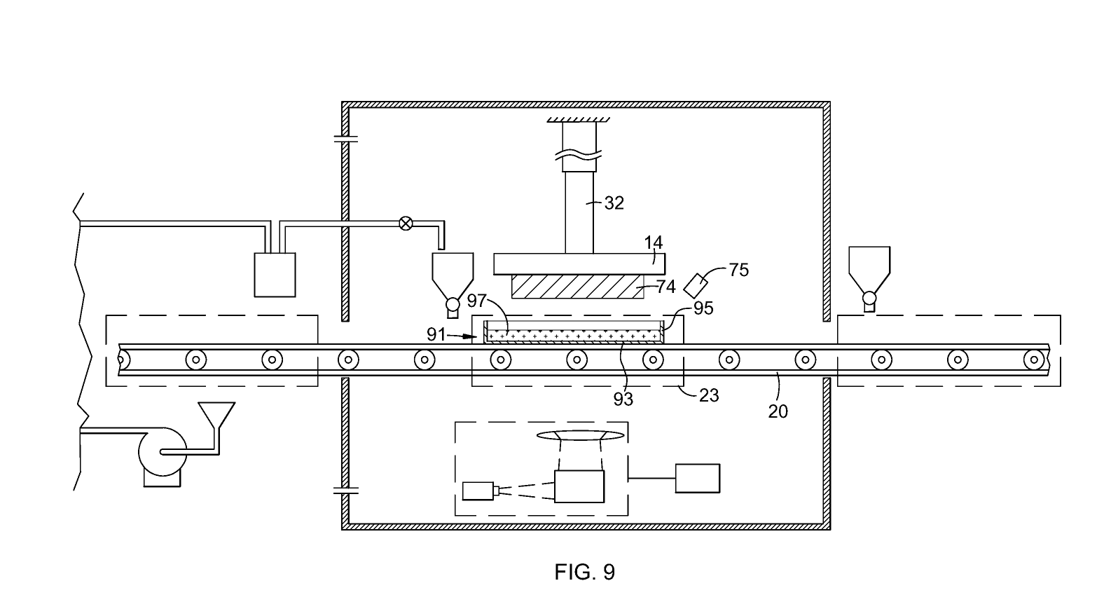

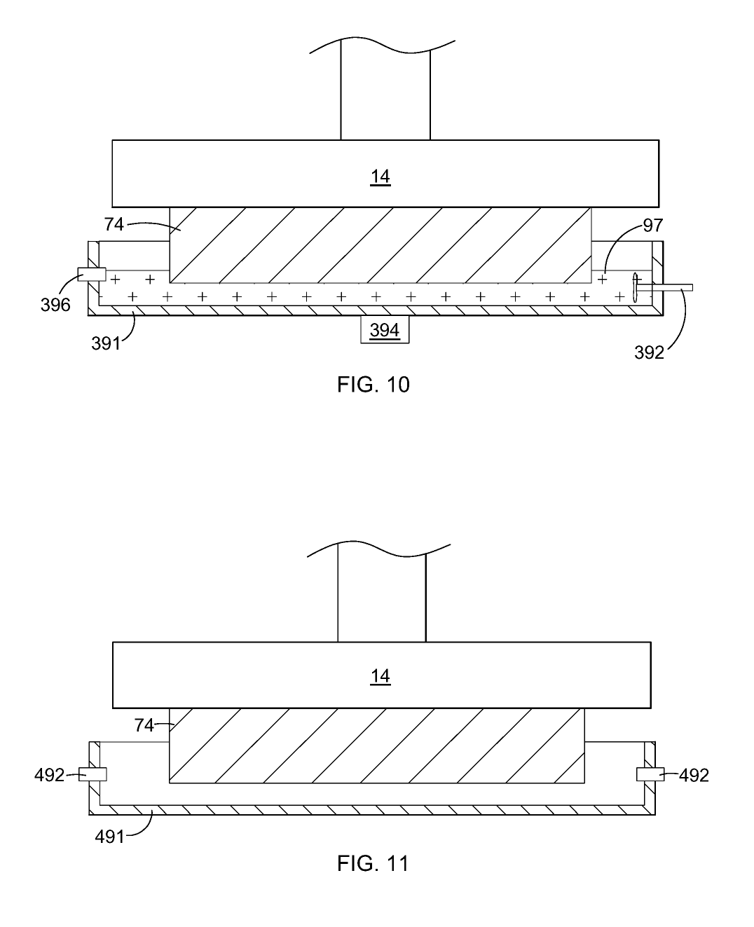

Optionally, the component 74 and/or the stage 14 may be cleaned to remove uncured resin R, debris, or contaminants between curing cycles. The cleaning process may be used for the purpose of removing resin R that did not cure or resin R that did not cure enough to gel during the selective curing step described above. For example, it might be desired to clean the component 74 and/or the stage 14 to ensure that no additional material or material contamination is present in the final component 74. For example, cleaning could be done by contacting the component 74 and/or the stage 14 with a cleaning fluid such as a liquid detergent or solvent. FIG. 9 shows one example of how this could be accomplished by providing a cleaning vat 91 containing the cleaning fluid. The cleaning vat 91 comprises a floor 93 surrounded by a peripheral wall 95. In use, the cleaning fluid 97 would be placed in the cleaning vat 91. The transport mechanism 20 would be used to move the vat 11 out of the build zone 23 and to move the cleaning vat 91 into the build zone 23. The stage 14 would then be lowered to bring the component 74 into contact with the cleaning fluid 97. Upon completion of the cleaning cycle, the stage 14 would then be raised to move the component 74 clear of the cleaning vat 91. Optionally, the cleaning process may include the introduction of some type of relative motion between the cleaning fluid 97 and the component 74. FIG. 10 illustrates a cleaning vat 391 (generally similar to cleaning vat 91) incorporating several different possible means for producing this relative motion. As one example, a mechanical mixing blade 392 may be used to agitate the cleaning fluid 97. As another example, an ultrasonic transducer 394 coupled to the cleaning vat 391 may be used to produce ultrasonic waves in the cleaning fluid 97. As another example, one or more nozzles 396 may be used to introduce jets of flowing cleaning fluid 97. As yet another example, appropriate actuators (not shown) may be used to produce relative motion of the stage 14 and the cleaning vat 391. Optionally, the cleaning process may include a “drying” step in which the freshly cleaned component 74 is positioned within an empty cleaning vat 491 (FIG. 11) with air nozzles 492 which would be used to direct jets of air at the component 74 for the purpose of blowing off or evaporating the cleaning fluid. Depending on the particular circumstances, the “drying” step may be sufficient to clean the component 74 in and of itself. Subsequent to the cleaning step, the transport mechanism 20 would then be used to move the cleaning vat 91 out of the build zone 23, and place the previous vat 11 (or a fresh vat 11) into the build zone.

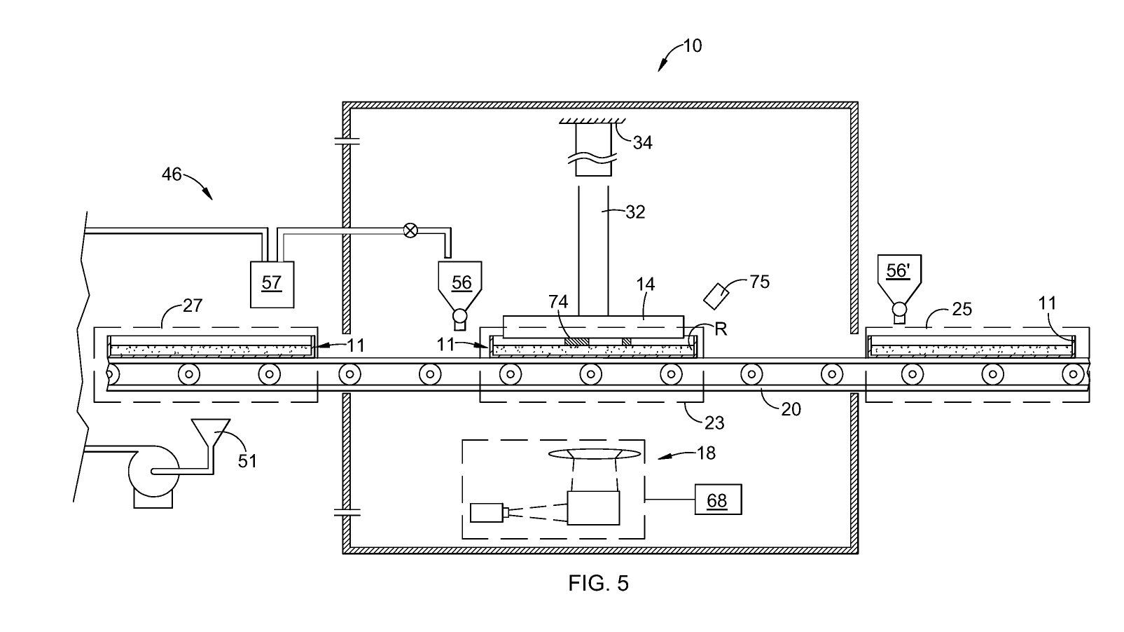

Subsequent processing depends upon whether the vat 11 is to be used for a single layer or for multiple layers, before being exchanged for another vat 11. If the vat 11 is to be used for multiple layers, and is filled with a sufficient amount of resin R for multiple layers, then the next step would be to position the stage 14 to define a new build layer region by using the actuator 32 as shown in FIG. 5. This allows the resin R within the vat 11 to flow into the new build layer region.

Where the vat 11 is to be used for multiple layers, and is filled prior to beginning the build cycle, the number of layers to be defined and cured before removing the vat 11 from the build zone 23 could be a predetermined number or a predetermined elapsed time. Alternatively, the number of layers to be defined in cured before removing the vat 11 from the build zone 23 could be determined on a real-time basis. For example, a sensor 75 (shown schematically in FIG. 1) such as an optical sensor, operably connected to the controller 68, could be provided to detect a property of the resin R related to the suitability of the resin R for continued use. For example, properties such as the presence or quantity of particulates or debris, opacity, viscosity, density, or other physical, thermal, chemical, or electrical properties could be measured. A threshold value may be predetermined for one or more of these properties, in the controller 68 may be programmed to stop the build cycle and indicate that the vat 11 should be removed from the build zone 23 upon detecting the measured value exceeding the predetermined threshold value or values.

Alternatively, if the vat 11 was initially filled only with a sufficient amount of resin R for one layer, then the stage 14 would be retracted out of the build zone 23, and then the new material reservoir 56 would be used to apply resin R to the build surface 22 to ready it for curing again. This cycle of preparing a vat 11, filling the vat 11 with resin R as needed, incrementing a layer, and selectively curing is repeated until the entire component 74 is complete.

If a particular vat 11 is intended to be used only for a single layer, it would not be refilled with resin R after the curing step.

When a particular vat 11 has been used to produce the desired number of layers, the vat 11 is then advanced via operation of vat transport mechanism 20 to move the now-used vat 11 out of the build zone and into the unloading zone 27 where excess cured or uncured resin R, filler, release agent, or other debris can be removed (a representative used vat is seen in the unloading zone in FIG. 5). The excess uncured resin R and filler flows into the recovery apparatus 46 and is recycled as described above.

Subsequent to unloading, the used vat 11 may be cleaned or otherwise rejuvenated and prepared for re-use by removing uncured resin R and other debris from the build surface 22. Non-limiting examples of suitable cleaning processes include brushing, abrading, scraping, vacuuming or blowing, absorbing, wiping, solvent rinsing, or combinations thereof. It will be understood that the process of cleaning or otherwise rejuvenating could be carried out in a remote location away from the apparatus 10.

The particular process or mechanism used to clean or otherwise rejuvenate the vat 11 is not specifically relevant to the present invention. The time required for the selected rejuvenation process may be taken into account when determining the initial quantity of the vats 11 needed such that the build process (specifically the curing step) would not have to be limited other than by the time required for the transport mechanism 20 to move a fresh vat 11 from the loading zone 25 to the build zone 23. Alternatively, the used vat 11 could be discarded, sent to an outside facility for reprocessing, or recycled.

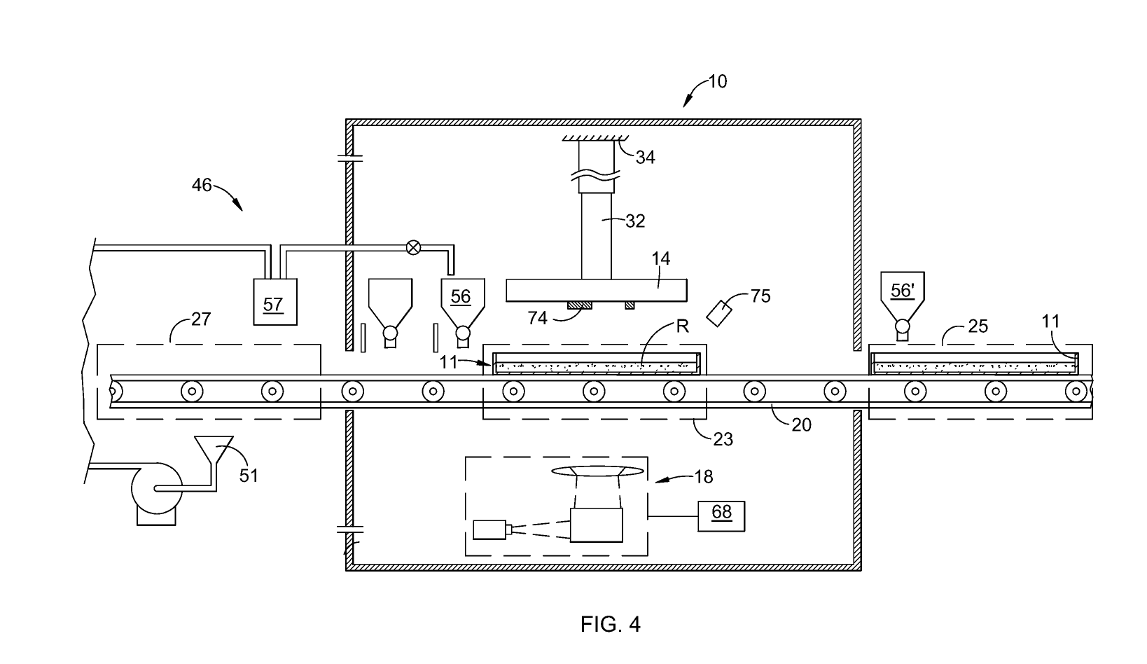

The process continues after the used vat 11 is transported out of the build zone 23. The transport mechanism 20 is used to move a fresh vat 11 into the build zone 23 (this movement may be concurrent with the removal of the used vat 11 as shown in FIG. 4) from the loading zone 25. As described above for the first vat 11, subsequent vats 11 may be provided as prefilled cartridges, or may be filled in the loading zone 25 or the building zone 23, with each filling step providing sufficient resin R for one or multiple layers. Once a filled vat 11 is positioned in the build zone 23, the projector 48 again projects a patterned image 56. Exposure to the radiant energy selectively cures resin R as described above, and joins the new layer to the previously-cured layer. This cycle of preparing a vat 11, incrementing a layer, selectively curing, and unloading the vat 11 is repeated until the entire component 74 is complete.

Where a scanned beam apparatus is used instead of a projector as seen in FIG. 8, the radiant energy source 68 emits a beam 66 and the beam steering apparatus 70 is used to cure the resin R by steering a focal spot of the build beam 66 over the exposed resin R in an appropriate pattern. The cycle of cycle of loading a vat 11, filling the vat 11 with resin R, and incrementing a layer is repeated. The radiant energy source 68 again emits a build beam 66 and the beam steering apparatus 70 is used to steer the focal spot of the build beam 66 over the exposed resin R in an appropriate pattern. The exposed layer of the resin R is exposed to the radiant energy which selectively cures resin R as described above, and joins it to the previously-cured layer above. This cycle of preparing a vat 11, incrementing a layer, and selectively curing, and unloading the vat 11 is repeated until the entire workpiece 74 is complete.

Optionally, a scanned beam apparatus may be used in combination with a projector. For example, a scanned beam apparatus may be used to apply radiant energy (in addition to that applied by the projector) by scanning one or multiple beams over the surface of the uncured resin R. This may be concurrent or sequential with the use of the projector.

Either curing method (projector or scanned) results in a component 74 in which the filler (if used) is held in a solid shape by the cured resin R. This component may be usable as an end product for some conditions. Subsequent to the curing step, the component 74 may be removed from the stage 14.

If the end product is intended to be composed of the filler (e.g. purely ceramic, glass, metallic, diamond, silicon, graphite, etc.), the component 74 may be treated to a conventional sintering process to burn out the resin R and to consolidate the ceramic or metallic particles. Optionally, a known infiltration process may be carried out during or after the sintering process, in order to fill voids in the component with a material having a lower melting temperature than the filler. The infiltration process improves component physical properties.

The method described herein has several advantages over the prior art. In particular, it eliminates a major pathway for build failures in vat-based photopolymerization. Another advantage of the method described herein is that it reduces cross-contamination risk in multi-material additive manufacturing relative to conventional methods. It also potentially has lower cost, less material waste, and higher process speed compared to prior art tape casting methods. Further, cleaning can be integrated into the printing process for multi-material AM which generally cannot be done with tape casting.

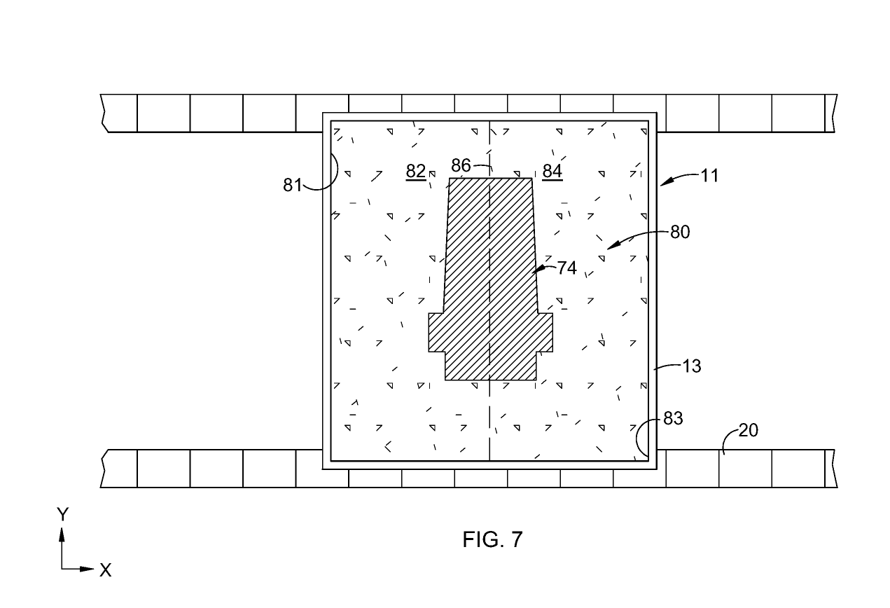

Referring now to FIG. 7, the vat 11 can divided to define multiple chambers. For example, a first chamber 81 and a second chamber 83 can be filled with different curable resins. The resins contained within the first chamber 81 and the second chamber 83 of the vat 11 can be cured simultaneously or sequentially. In this manner, any of the individual layers may comprise two or more material combinations. FIG. 7 illustrates an exemplary layer 80 showing a cross-section of the component 74 superimposed thereupon. The layer 80 is divided into a first section 82 including a first combination of resin R and filler, and a second section 84 including a second combination of resin R and filler. A dashed line 86 indicates the division between the two sections 82, 84. The shape, size, and number of sections, and number of different material combinations within a given layer may be arbitrarily selected. If multiple material combinations are used in one layer, then the deposition steps described above would be carried out for each section of the layer.

The foregoing has described a method and apparatus for additive manufacturing. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method for producing a component layer-by-layer, comprising the steps of:
placing in a loading zone a vat having a floor including at least a portion which is transparent, the floor defining a build surface;
loading the vat into a build zone of an additive manufacturing apparatus utilizing a vat transport mechanism;
executing a build cycle, including the steps of:
positioning a stage relative to the build surface so as to define a layer increment in a radiant-energy-curable resin contained within the vat;
selectively curing the resin using an application of radiant energy in a specific pattern so as to define the geometry of a cross-sectional layer of the component;
moving the vat and the stage relatively apart so as to separate the component from the build surface;
unloading the vat from the build zone into an unloading zone; and
repeating the steps of placing, loading, executing the build cycle, and unloading for a plurality of layers, using a plurality of vats in series, until the component is complete.

2. The method of claim 1 wherein, for at least one of the plurality of vats, the steps of: positioning the stage, selectively curing the resin, and moving the floor and the stage relatively apart are repeated for multiple layers, before the step of unloading the vat from the build zone.

3. The method of claim 2 wherein the step of unloading the vat from the build zone is carried out after a specified number of layers.

4. The method of claim 2 wherein the step of unloading the vat from the build zone is carried out in response to a sensed property of the resin in the vat exceeding a predetermined threshold.

5. The method of claim 2 wherein at least one of the plurality of vats contains sufficient resin for multiple layers prior to the step of executing the build cycle.

6. The method of claim 1 wherein the build cycle includes, prior to the step of positioning the stage, a step of filling the vat with the resin.

7. The method according to claim 1 wherein at least one of the plurality of vats is filled with the resin while it is in the loading zone or in the build zone.

8. The method according to claim 1 wherein at least one of the plurality of vats is pre-filled with resin prior to being placed in the loading zone.

9. The method according to claim 1, further comprising the steps of:
moving the vat into a resin recovery system;
removing remaining resin from the vat; and
reusing the vat at least once.

10. The method of claim 1 further comprising the steps of:
filtering the remaining uncured resin; and
further using the filtered uncured resin in an additive manufacturing process.

11. The method of claim 1 further comprising the steps of:
filtering the remaining uncured resin; and
returning the filtered uncured resin to another vat or to the same vat.

13. The method of claim 1 wherein the resin includes a particulate material filler.

14. The method of claim 13 further comprising sintering the component to burn out the cured resin and consolidate the filler.

15. The method of claim 14 further comprising infiltrating a lower-melting-temperature material into the component during or after sintering.

16. The method of claim 1 wherein the application of radiant energy is applied by projecting a patterned image comprising a plurality of pixels.

17. The method of claim 16 wherein the patterned image is shifted during the application of radiant energy.

18. The method of claim 16 wherein additional radiant energy is applied by scanning at least one build beam over the surface of the resin.

19. The method of claim 1 wherein the radiant energy is applied by scanning a build beam over the surface of the resin.

20. The method of claim 1 further comprising cleaning at least one of the component and the stage, wherein the cleaning is carried out after the step of moving the vat and the stage relatively apart.

21. The method of claim 20 wherein the step of cleaning includes:
moving a vat containing a cleaning fluid into the build zone;
moving the stage so as to contact at least one of the component and the stage with the cleaning fluid; and
moving the stage so as to separate the stage and the component from the cleaning fluid.

22. The method of claim 20 wherein the step of cleaning includes contacting at least one of the component and the stage with a cleaning fluid.

23. The method of claim 22 wherein the step of cleaning includes introducing relative movement between the cleaning fluid and at least one of the component and the stage.

24. The method of claim 1 wherein a non-stick coating is disposed between the floor and the resin.

25. An additive manufacturing apparatus, comprising:
a vat transport mechanism operable to selectively move a series of vats each including a floor defining a build surface in sequence through a build zone defined within the apparatus;
a stage positioned adjacent the build zone and configured to hold a stacked arrangement of one or more cured layers of a radiant-energy-curable resin;
a mechanism operable to manipulate a relative position of the build surface and the stage;
a radiant energy apparatus positioned adjacent to the build zone opposite to the stage, and operable to generate and project radiant energy through the floor in a predetermined pattern.

26. The apparatus according to claim 25, further comprising a source for a resin.

27. The apparatus of claim 25, further comprising:
a plurality of vats positioned on the vat transport mechanism, wherein each vat defines a build surface; and
a source for a curable first resin, operable to deposit the curable first resin on the build surface.

28. The apparatus of claim 27, wherein the source for resin is configured to deposit the curable first resin on the build surface within the build zone.

29. The apparatus of claim 27, wherein the source for resin is configured to deposit the curable first resin on the build surface outside the build zone.

30. The apparatus of claim 25, wherein the vat transport mechanism is operable to selectively move a vat between a loading zone and a build zone.

31. The apparatus of claim 25, wherein the vat transport mechanism is operable to selectively move a vat between an unloading zone and the build zone.

32. The apparatus of claim 25 comprising a source for a second resin.

33. The apparatus of claim 32, wherein the second resin is different than the first resin.

34. The apparatus of claim 32, wherein at least a portion of the second resin comprises the first resin.

35. The apparatus of claim 25 further comprising a resin recovery apparatus.

36. The apparatus of claim 35, wherein the resin recovery apparatus includes a filter.

37. The apparatus of claim 27 wherein at least a portion of the floor of each vat includes a non-stick coating.

38. The apparatus of claim 27 wherein at least a portion of the floor of each vat is oxygen-permeable.
